(19) United States
(12) Patent Application Publication
(10) Pub. No.: US 2014/0089672 A1
(43) Pub. Date: Mar. 27, 2014

(54) WEARABLE DEVICE AND METHOD TO GENERATE BIOMETRIC IDENTIFIER FOR AUTHENTICATION USING NEAR-FIELD COMMUNICATIONS

(71) Applicants: Michael Edward Smith Luna, San Jose, CA (US); Thomas Alan Donaldson, London (GB)

(72) Inventors: Michael Edward Smith Luna, San Jose, CA (US); Thomas Alan Donaldson, London (GB)

(73) Assignee: AliphCom, San Francisco, CA (US)

(21) Appl. No.: 13/802,409

(22) Filed: Mar. 13, 2013

Related U.S. Application Data
(60) Provisional application No. 61/705,591, filed on Sep. 25, 2012.

(51) Int. Cl. H04L 9/32

(52) U.S. Cl. CPC H04L 9/3231
USPC 713/186

(57) ABSTRACT

Techniques associated with a wearable device and method to generate biometric identifier for authentication using near-field communications are described, including capturing data associated with a habitual activity, a physiological characteristic, and a motion pattern using a wearable device, generating a biometric identifier using the data, storing the biometric identifier on the wearable device, and authenticating a user using the biometric identifier.

### CROSS-REFERENCE TO RELATED APPLICATIONS

This application claims the benefit of U.S. Provisional Patent Application No. 61/705,591 (Attorney Docket No. ALI-151P), filed Sep. 25, 2012, which is incorporated by reference herein in its entirety for all purposes.

### FIELD

The present invention relates generally to electrical and electronic hardware, computer software, wired and wireless network communications, and computing devices. More specifically, techniques related to a wearable device and method to generate biometric identifier for authentication using near-field communications are described

### BACKGROUND

Conventional devices and techniques for authenticating, or verifying the identity of, a user in order to conduct a transaction (i.e., a financial transaction) securely are cumbersome and inefficient. A typical method of identification or authentication of a user to a system for a transaction involves a personal identification number (PIN), which is a numeric password unique to a user that is typically entered into a physical or virtual keypad to gain access or entry to a system. Conventional techniques use PINs to authenticate a user to conduct a transaction. Other conventional techniques exist for making payments using portable devices installed with near field communication (NFC) capabilities. However, these conventional techniques and devices are unreliable for various reasons. They are vulnerable to being stolen (i.e., obtained and used by an unauthorized user) or being forgotten. They are not linked directly to aspects unique to a user's identity, and it requires the physical act of entering numbers, either directly on a physical keypad, on a touchscreen, or other interface.

Other conventional device and techniques used in identification and authentication of a user include the use of biometric information, such as a fingerprint, a gait or speech pattern. However, conventional approaches to using biometric information typically focus on a single, biological characteristic or trait, and often are not well-suited for authenticating a person to engage in a transaction securely. Such approaches lack the ability to reliably determine the identity of a person or whether a person is authorized to conduct a transaction. Also, such conventional approaches often require highly specialized devices that are not available or convenient (i.e., not portable) for conducting daily transactions.

Thus, what is needed is a solution for a wearable device and method to generate biometric identifier for authentication using near-field communications without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary biometric identifier generator based on data acquired by one or more sensors disposed in a wearable device;

FIG. 2 illustrates an exemplary identifier constructor in association With a wearable device;

FIG. 3 illustrates exemplary types of data used by an identifier constructor in association with a wearable device;

FIG. 4 illustrates another exemplary identifier constructor configured to adapt to changes in a user;

FIG. 5 is an exemplary flow diagram for generating a LifeScore as a biometric identifier;

FIG. 6 illustrates an exemplary computing platform disposed in or associated with a wearable device;

FIG. 7 illustrates an exemplary system for authenticating a user for a transaction using a wearable device; and

FIG. 8 illustrates an exemplary system for authenticating a user for access using a wearable device.

### DETAILED DESCRIPTION

Various embodiments or examples may be implemented in numerous ways, including, as a system, a process, an apparatus, a user interface, or a series of program instructions on a computer readable medium such as a computer readable storage medium or a computer network Where the, program instructions are sent over optical, electronic, or wireless communication links, In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may he practiced according to the claims without sonic or all of these specific details. For clarity, technical material that is known in the technical fields related to the examples has not been described in detail to avoid unnecessarily obscuring the description.

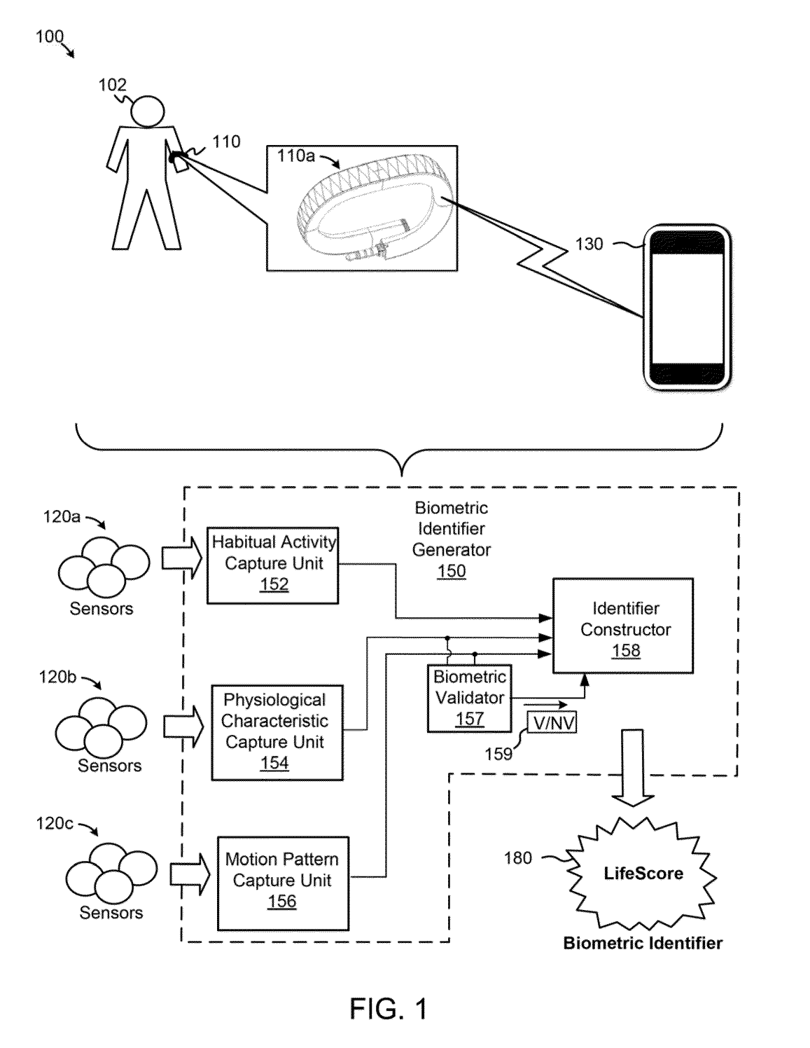

FIG. 1 illustrates an exemplary biometric identifier generator based on data acquired by one or more sensors disposed in a wearable device. Diagram 100 depicts a person (or “user”) 102 wearing or carrying a wearable device 110 configured to capture data for authenticating the identity of person 102. Examples of data captured for authenticating an identity include data related to activities of user 102, including habitual activities, data related to physiological characteristics, including biological-related functions and activities, data related to motion pattern characteristics, including motion-related patterns of, for example, the limbs or other portions of user 102 (e.g., patterns of limb movement constituting a gait or a portion thereof) and/or a corresponding activity in which user 102 is engaged. Biometric identifier generator 150 is not limited to the above-described data and can use any types of data can be captured and/or used for purposes of authenticating an identity of a user.

Also shown in FIG. 1 is a biometric identifier generator 150 configured to acquire data generated by or at for example, sensors 120a, 120b, and 120c, and is further configured to generate a biometric, identifier (“LifeScore”) 180 based on the acquired data. A LifeScore, as biometric identifier 180, may include data that (e.g., in the aggregate) can be used to uniquely and positively identify an individual and/or distinguish the individual from a relatively large sample size of other individuals in at least some embodiments, a LifeScore of user 102 may be a composite of one or more habitual activities, one or more motion pattern characteristics, and/or one or more physiological and biological characteristics. For example, biometric identifier 180 can be based on an aggregation of data representative of physiological (and biological) characteristics from one or more sensors 120b, data representative of physical activities from one or more sensors 120a (e.g., a single activity, such as sleeping, walking, eating, etc., or a combination of activities that can, for example, constitute a daily routine), and/or motion patterns from one or more sensors 120c. In the example shown, biometric identifier generator 150 may be configured to include a habitual activity capture unit 152, a physiological characteristic capture unit 154, and a motion pattern capture unit 156. Also included is an identifier constructor 158 configured to generate a composite biometric identifier 180 based on data or subsets of data from habitual activity capture unit 152, physiological characteristic capture unit 154, and motion pattern capture unit 156.

Habitual activity capture unit 152 is configured to acquire data representing physical and/or behavior characteristics associated with or derived from one or more activities. In some embodiments, habitual activity capture unit 152 can also be configured to capture data for individual activities and to characterize (e.g., categorize) such data. For example, habitual activity capture unit 152 can identify an activity in which user 102 is participating, as well as the characteristics of the activity (e.g., the rate at which the activity is performed, the duration of time over which the activity is performed, the location of the activity the identities of other people related to the performance of the activity (e.g., the identities of people with which user 102 interacts, such as by phone, email, text, or in any other manner), the time of day, and the like). Further, habitual activity capture unit 152 can identify a broader activity composed of sub-activities. For example, habitual activity capture unit 152 can determine that user 102 is at work if he or she walks in patterns (e.g., walking in patterns such as between one's desk or cubical to others desks or cubicles), converses with other people (face-to-face and over the phone), and types on a keyboard (e.g., interacts with a computer) from the hours of 8 am to 7 pm on a weekday. In some embodiments, an activity can be determined by the use of one or more accelerometers, which can be included in a subset of sensors 120a. Further, motion pattern capture unit 156 can be used by habitual activity capture unit 152 to identify certain patterns of motion (e.g., steps or strides) that constitute an activity, such as walking or jogging.

Examples of such activities include physical activities, such as sleeping, running, cycling, walking, swimming, as well as other aerobic and/or anaerobic activities.

Also included are incidental activities that are incidental (i.e., not intended as exercise) to, for example, a daily routine, such as sitting stationary, sitting in a moving vehicle, conversing over a telephone, typing, climbing stairs, carrying objects (e.g., groceries), reading, shopping, showering, laundering clothes, cleaning a house, and other activities typically performed by a person in the course of living a certain lifestyle. Examples of characteristics of the above-mentioned activities include but are not limited to “who” user 102 has called (e.g., data can include other aspects of the call, such as duration, time, location, etc., of the phone call to, for example, the mother of user 102), what time of the day user 102 wakes up and goes to bed, the person with whom user 102 texts the most (including duration, time, location, etc.), and other aspects of any other types of activity,

Such activities can each be performed differently based on the unique behaviors of each individual, and these activities are habitually performed. consistently and generally periodically. Therefore, multiple activities can constitute a routine, whereby individuals each can perform such routines in individualized manners. As used herein, the term “habitual activity” can refer to a routine or pattern of behavior that is repeatable and is performed in a consistent manner such that aspects of the pattern of behavior can be predictable for an individual. In view of the foregoing, the term “habitual activities” can refer to a series of activities (habitual or otherwise), which may be performed in a certain order, whereby the collective performance of the habitual activities over a period of time (e.g., over a typical workday) is unique to aspects of the psychology of user 102 physical manifestations of the mental functions that gives rise to decisions of what activities to perform and the timing or order thereof) and the physiological and/or biology of user 102. Therefore, habitual activities and the patterns of their performance can be used to uniquely identify user 102. Biometric identifier generator 150 is configured to determine which deviations, as well as the magnitude of the deviations, from expected data values (e.g., data representing a daily routine) that can be used for authentication purposes. For example, biometric identifier generator 150 can adapt variations in activities performed by user 102, such as going to a doctor's office during a workday.

Physiological characteristic capture unit 154 is configured to acquire data representing physiological and/or biological characteristics of user 102 from sensors 120b that can acquired before, during, or after the performance of any activity, such as the activities described herein, In some embodiments, physiological characteristic capture unit 154 can also be configured to capture data for individual physiological characteristics heart rate) and to either characterize (e.g., categorize) such data or use the physiological data to derive other physiological characteristics (e.g., VO2 max), Sensor data from sensors 120b includes data representing physiological information, such as skin conductivity, heart rate (“HR”), blood pressure (“BP”), heart rate variability (“HRV”), body temperature, skin conductance (e.g., galvanic skin response, or GSR), and the like. Optionally, sensor data from sensors 120b also can include data representing location (e.g., GPS coordinates) of user 102, as well as other environmental attributes in which user 102 is disposed (e.g., ambient temperatures, atmospheric pressures, amounts of ambient light, etc.). In some embodiments, sensors 120b can include image sensors configured to capture Facial features, audio sensors configured to capture speech patterns and voice characteristics unique to the physiological features (e.g., vocal cords, etc.) of individual 102, and any other type of sensor for capturing data about any attribute of a user.

Motion pattern capture unit 156. is configured to capture data representing motion from sensors 120c based on patterns of three-dimensional movement of a portion of a wearer, such as a wrist, leg., arm, ankle, head, etc., as well as the motion characteristics associated with the motion. For example, the user's wrist motion during walking exhibits a “pendulum-like” motion pattern over time and three-dimensional space. During walking, the wrist and wearable device 110a is generally at waist-level as the user walks with arms relaxed (e.g., swinging of the arms during walking can result in an arc-like motion pattern over distance and time). Given the physiological structure of user 102, motion pattern capture unit 156 can derive quantities of foot strikes, stride length, stride length or interval, time, and other data (e.g., either measureable or derivable) based on wearable device 110a being disposed either on a wrist or ankle, or both. In some embodiments, an accelerometer in mobile computing/communication device 130 can be used in concert with sensors 120c to identify a motion pattern. In view of the foregoing, motion pattern capture unit 156 can be used to capture data representing a gait of user 102, thereby facilitating the identification of a gait pattern associated to the particular gait of user 102. As such an identified gait pattern can be used for authenticating the identity of user 102. Note, too, that motion pattern capture unit 156 may be configured to capture other notion patterns, such of that generated by an arm of user 102 (including wearable device 110a) that performs a butterfly swimming stroke. Other motion patterns can be identified from sensors 120c to indicate the motions in three-dimensional space when brushing, hair or teeth, or any other pattern of motion to authenticate or identify user 102.

identifier constructor 158 is configured to generate a composite biometric identifier 180 based on data or subsets of data from habitual activity capture unit 152, physiological characteristic capture unit 154, and motion pattern capture unit 156. For example, subsets .f data from habitual activity capture unit 152, physiological characteristic capture unit 154, and motion pattern capture unit 156 can be expressed in various different ways (e.g., matrices of data) based on any of the attributes of the data. captured (e.g., magnitude of a pulse, frequency of a heartbeat, shape of an ECG waveform or any waveform, etc), in some examples, identifier constructor 158 is configured to compare captured data against other data (e.g., predefined data or archived data representing likely matches) to determine whether LifeScore 180 identifies positively user 102 for authorization purposes.

Further, FIG. 1 depicts biometric identifier generator 150 including a biometric validator 157 configured to determine modes of operation of biometric identifier generator 150 in which an authentication of the identity of a user is either validated or invalidated. As shown, biometric validator 157 is configured to receive data from physiological characteristic capture unit 154 and/or motion pattern capture unit 156. In some embodiments, biometric validator 157 is configured to determine the validity of an authenticated identify as a function of the presence and/or quality of a physiological signal (e.g., heart rate) and/or the presence and/or quality of patterned, motion e.g., the gait of the user. According to some embodiments, biometric validator 157 is configured to operate as a “wore/not-worn detector.” In particular, biometric validator 157 determines when wearable device 110a is removed from the wearer, and generates valid/not-valid (“V/NV”) signal 159 that includes data indicating the LifeScore is invalid due to the removal of the wearable device. Consequently, unauthorized use is prevented when identifier constructor 158 receives signal 159, and, in response, causes invalidation of LifeScore 180. Further, biometric validator 157 determines when wearable device 110a is being worn again by the wearer, and generates valid/not-valid (“V/NV”) signal 159 that includes data indicating the LifeScore 180 is valid. In this case, authorized use is permitted when identifier constructor 158 receives signal 159 specifying that data from physiological characteristic capture unit 154 and/or motion pattern capture unit 156 is valid (i.e., the wearable device is being worn by art authenticated user), which causes identifier constructor 158 to validate the authenticity of LifeScore 180. An authenticated LifeScore 180 can then be used as a personal identification number (“PIN”) for financial transactions, for example, or as a passcode or an equivalent.

According to various embodiments, any or all of the elements (e.g., sensors 120a to 120c and biometric identifier generator 150), or sub-elements thereof, can be disposed in wearable device 110a or in mobile computing/communication device 130, or such sub-elements can be distribute among wearable device 110a and in mobile computing/communication device 130 as well as any other computing device (not shown), Wearable device 110a is not limited to a human as user 102 and can be used in association with any animal, such as a pet. Note that more or fewer units and sets of data can be used to authenticate user 102. Examples of wearable device 110a, or portions thereof, may be implemented as disclosed, or otherwise suggested by U.S. patent application Ser. No. 13/181,500 filed Jul. 12, 2011 (Docket No. ALI-016), entitled “Wearable Device Data Security,” and U.S. patent application Ser. No. 13/181,500 filed Jul. 12, 2011, entitled “Wearable Device Data Security,” U.S. patent application Ser. No. 13/181,513 filed Jul. 12, 2011 (Docket. No. ALI-019), entitled “Sensory User Interface,” and U.S. patent application Ser. No. 13/181,498 filed Jul. 12, 2011 (Docket No, ALI-018), entitled “Wearable Device and Platform for Sensory Input,” all of which are herein incorporated by reference.

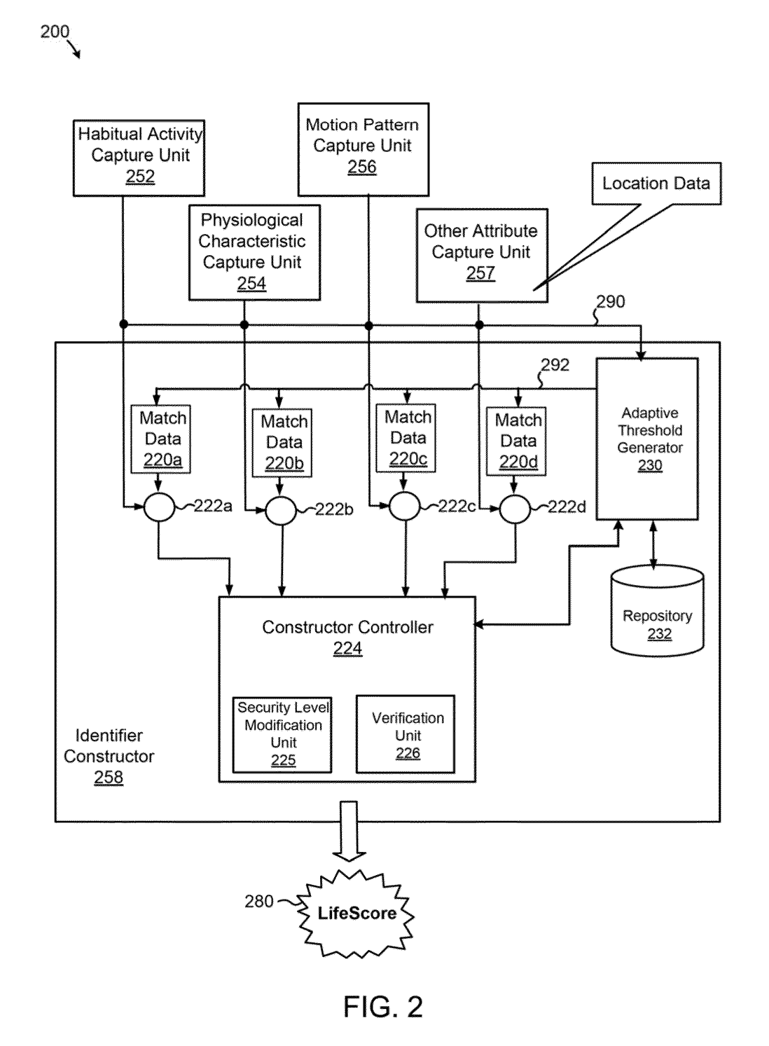

FIG. 2 illustrates an exemplary identifier constructor in association with a wearable device. Diagram 200 depicts identifier constructor 258 configured to interact, without limitation, with habitual activity capture unit 252, physiological characteristic capture unit 254, and motion pattern capture unit 256 to generate a biometric identifier (“LifeScore”) 280. Note that identifier constructor 258 is configured to acquire other data to facilitate authentication of the identity of a user. The other data can be used to supplement, replace, modify, or otherwise enhance the use of the data obtained from habitual activity capture unit 252, physiological characteristic capture unit 254, and motion pattern capture unit 256. For example, identifier constructor 258 can be configured to acquire other data from other attribute capture unit 257, which, in this example, provides location data describing the location of a wearable device.

Identifier constructor 258 includes comparator units 222a, 222b, 222c, and 222d to compare captured data from habitual activity capture unit 252, physiological characteristic capture unit 254, motion pattern capture unit 256, and other attribute capture unit 257 against match data 220a, 220b, 220c, and 220d, respectively. Match data. 220a, 220b, 220c, and 220d represents data is indicative of the user, whereby matches to the captured data indicates that the user is likely using the wearable device. As such, match data 220a, 220b, 220c, and 220d specifies data for matching captured data to authenticate the identity of a user. Match data 220a, 220b 220c, and 220d, in some examples, represent adaptive ranges of data values (i.e., tolerances) in which matches are determined to specify the user is positively identified.

Identifier constructor 258 also includes an adaptive threshold generator 230 configured to provide threshold data for matching against, captured data to determine whether a component of biometric identifier 280 (e.g., data from one of habitual activity capture unit 252, physiological characteristic capture unit 254, motion pattern capture unit 256, and other attribute capture unit 257) meets its corresponding threshold. The threshold is used to determine whether the component of biometric identifier 280 indicates a positive match to the user. Adaptive threshold generator 230 is configured to adapt or modify the thresholds (e.g., increase or decrease the tolerances by which the captured component data can vary) responsive to one or more situations, or one or more commands provided by construction controller 224. In some cases, adaptive threshold generator 230 provides match data 220a, 220b, 220c, and 220d that includes ranges of data acceptable to identify a user.

For example, adaptive threshold generator 230 can adapt the thresholds (e.g. decrease the tolerances to make authentication requirements more stringent) should one of habitual activity capture unit 252, physiological characteristic capture unit 254, and motion pattern capture unit 256 fail to deliver sufficient data to identifier constructor 258. To illustrate, consider that a user is sitting stationary for an extended period of time or is riding in a vehicle. in this case, data from motion pattern capture unit 256 would likely not provide sufficient data representing a “gait” of the user as the limbs of the user are not likely providing sufficient motion. Responsive to the receipt of insufficient gait data, construction controller 224 can cause adaptive threshold, generator 230 to implement more strict tolerances for data from habitual activity capture unit 252 and physiological characteristic capture unit 254.

For instance, construction controller 224 can cause adaptive threshold generator 230 to implement more stringent thresholds for habitual activity-related, data and psychological-related data. Thus, the shape of a pulse waveform or an ECG waveform may be scrutinized to ensure the identity of a user is accurately authenticated. Alternatively, construction controller 224 can cause adaptive threshold generator 230 to implement location-related thresholds, whereby location data from other attribute capture unit 257 are used to detect whether user is at or near a location associated with the performance of habitual activities indicative of a daily routine. Generally, the more activities performed at locations other than those indicative of a daily routine may indicate that an unauthorized user is wearing the wearable device.

Repository 232 is configured to store data provided by adaptive threshold generator 230 as profiles or templates. For example data via paths 290 can be used to form or “learn” various characteristics that are associated with an authorized user. The learned characteristics are stored as profiles or templates in repository 232 and can be used to form data against which capture data is matched. For example, repository 232 can provide match data 220a, 220b, 220c, and 220d via paths 292. In a specific embodiments, repository 232 is configure to store a template of a user's gait, physical activity history, and the shape and frequency of pulse wave to create a biometric “fingerprint,” such as the LifeScore.

Constructor controller 224 can be configured to control the elements of identifier constructor 258, including the comparators and the adaptive threshold generator, to facilitate the generation of biometric identifier 280. Constructor controller 224 can include a verification unit 226 and a security level modification unit 225. Verification unit 226 is configured to detect situations in which insufficient data is received, and is further configured to modify the authentication process (e.g., increase the stringency of matching data), as described above, to ensure authentication of the identity of a user. Security level modification unit 225 is configured to adjust the number of units 252, 254, 256, and 257 to use in the authentication process based on the need for enhanced security. For example, if the user is on walk in a neighborhood, there may be less need for stringent authentication compared to situations in which the user is at a location in which financial transactions occur (e.g., at an ATM, at a point-of-sale system in a grocery store, etc.). As such, security level modification unit 225 can implement unit 257 to use location data for matching against historic location information to determine whether, for example, a point-of-sale system is one that the user is likely to use (e.g., based on past locations or purchases). Archived purchase information can be stored in repository 232 to determine whether a purchase is indicative of a user (e.g., a large purchase of electronic equipment at a retailer that the user has never shopped at likely indicates that the wear is unauthorized to make such a purchase). Thus, security level modification unit 225 can use this and similar information to modify the level of security to ensure appropriate levels of authentication.

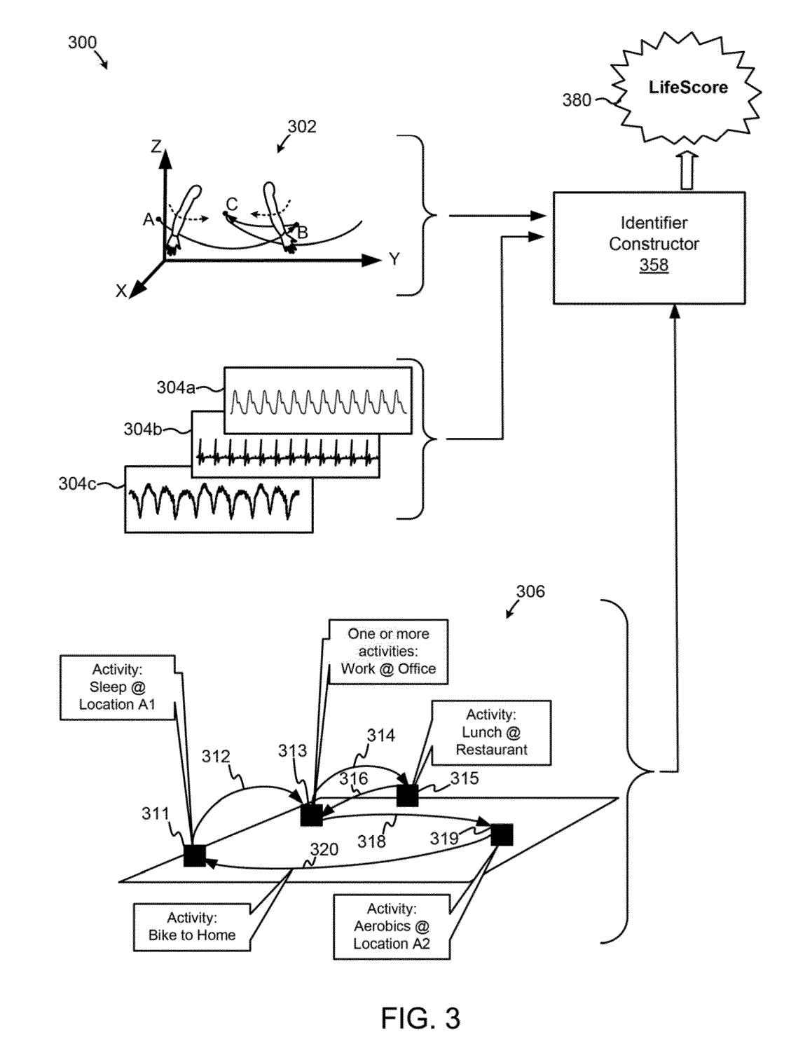

FIG. 3 illustrates exemplary types of data used by an identifier constructor in association with a wearable de⁻vice. Functional diagram 300 depicts an identifier constructor 358 configured to generate a biometric identifier 380 based on data depicted in FIG. 3. For example, biometric identifier 380 may be formed from a first component of data 302 representing gait-related data, and a second component of data 304 representing physiological-related data, such as a pulse pressure wave 304a (or equivalent), ECG data 304b or pulse-related data 304c (including waveform shape-related data, including pulsed-based impedance signals and data). Further, biometric identifier 380 can be formed from a third component of data 306 that includes activity data (e.g., habitual activity data) and/or location data. As shown, data 306 is depicted conceptually to contain information about the locations, such as a home 311, an office 133, a restaurant 315, and a gymnasium 319. Further, data 306 represents multiple subsets of activity data indicative of activities performed at the depicted locations (e.g., eating lunch). Also, data 306 includes a subset of data 312 (e.g., activity of riding a bicycle to work), subsets of data 314 and 316 (e.g., activity of walking to and from a restaurant), and subsets of data 318 and 320 (e.g., activity of riding a bicycle to a gym and back home). Based on data 302, 304, and 306, identifier constructor 358 can therefore determine biometric identifier 380.

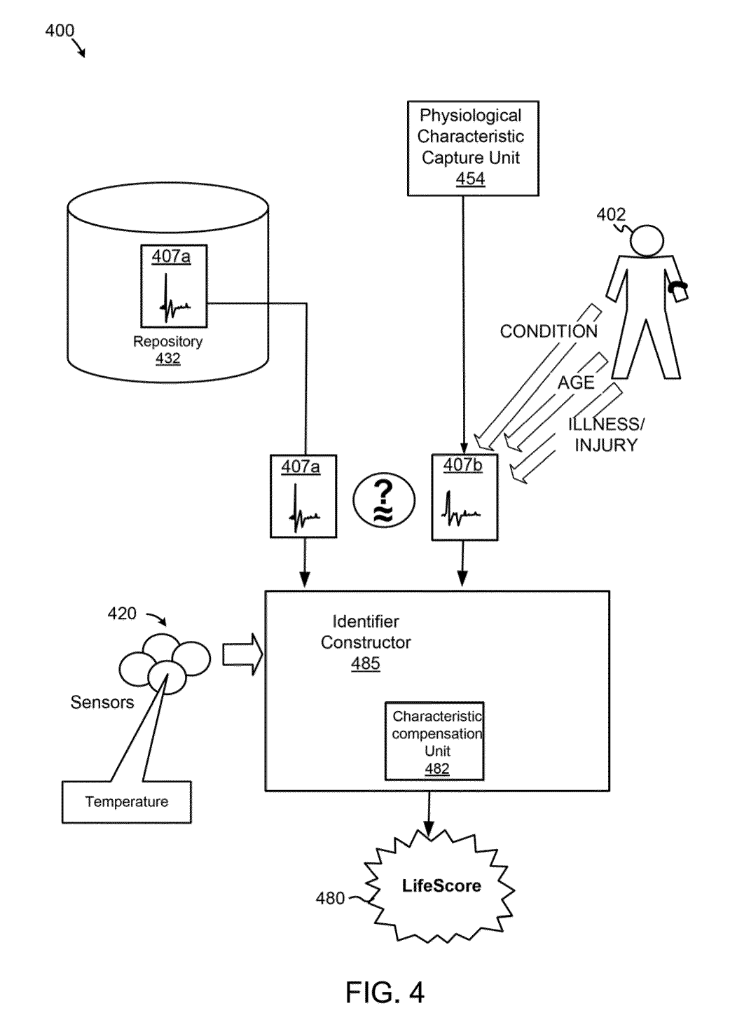

FIG. 4 illustrates another exemplary identifier constructor configured to adapt to changes in a user. As shown in diagram 400, a user 402 may change habits, or may experience in changes physiological or motion pattern characteristics. Typically, a condition e.g., pregnancy), age, or illness/injury can impact the physiological or motion pattern characteristics of a user. For example, a user's speech, gait or stepping pattern may change due to injury or accident Further, a user's pulse wave and heart-rate can change due to illness, age or changes in fitness levels (e.g., increase aerobic capacities and lowered heart rates). Since not all these factors can change at once (or are not likely to at the same approximate time), the determination of LifeScore 480 by identifier constructor 485 can include monitoring the rate(s) of change of one or more of these parameters or characteristics, If one or more of these parameters or characteristics change too quickly, identifier constructor 485 and can flag a change in identification (e.g., positive identification), or the need to modify the authentication process when many of characteristics change.

In some examples. identifier constructor 485 can include a characteristic compensation unit 482 that is configured to compensate for, or at least identify, changes in user characteristics. Characteristic compensation unit 482 can be configured to detect changes in characteristics, due to injury, accident, illness, age or changes in fitness levels, among other characteristics. Further, characteristic compensation unit 482 can be configured to confirm a source of one or more changes in characteristics to ensure authentication. To illustrate, consider that identifier constructor 485 is configured to receive data 407a representing a pulse-related waveform from repository 432 to perform a comparison operation. As shown, captured data 407b from physiological characteristic capture unit 454 indicates a change (e.g., a slight change) in shape of the user's pulse-relate waveform The change in the shape of a waveform can be caused, for example, by a fever due to a virus. To confirm this characteristic compensation unit 482 can use a temperature sensor in the subset of sensors 420 to confirm a temperature of the user (e.g., a temperature of 102° F.) indicative of fever. Based on confirmation of the presence of a fever, identifier constructor 485 is more likely to accept captured data 407b as valid data and is less likely to conclude that a user is unauthorized.

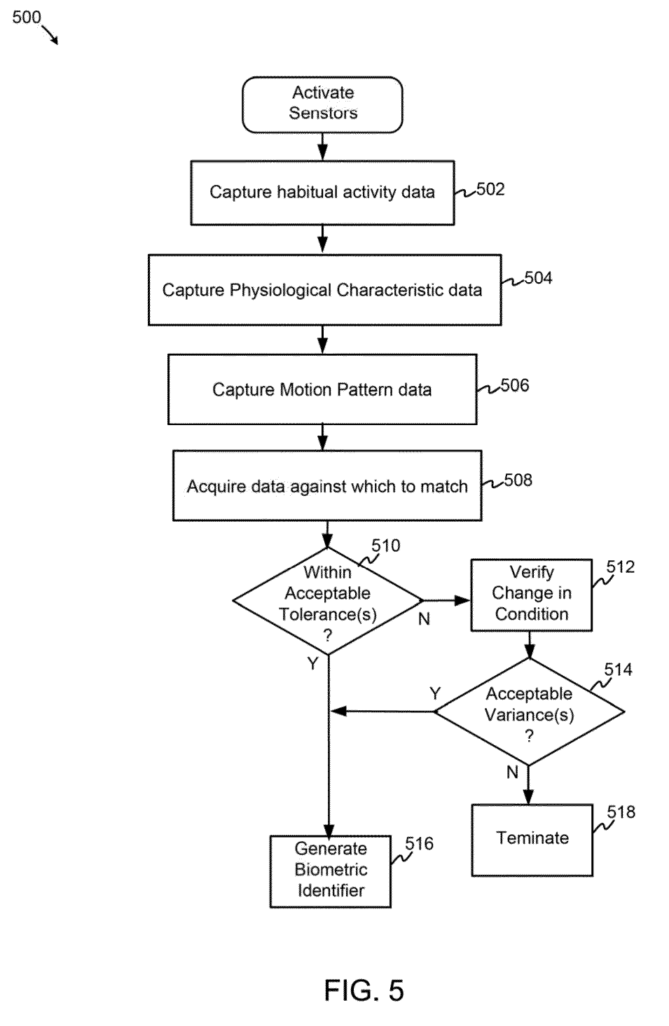

FIG. 5 is an exemplary flow diagram for generating a LifeScore as a biometric identifier. At 502, flow 500 activates sensors and captures habitual activity characteristic data. Physiological characteristic data can be captured at 504, and motion pattern characteristic data can be captured at 506. At 508, flow 500 provides for the acquisition of data (e.g., match data) against which to match. At 510, a determination is made as to whether one or more characteristics are within acceptable tolerances to authenticate an identity of a user. If so, flow 500 continues to 516, at which a biometric identifier is generated. If not, flow 500 continues to 512, at which a change in condition may be verified (e.g., a deviation from expected or allowable ranges of data due to, for example. an illness). At 514, a determination is made whether the change in condition (and/or characteristic) is within acceptable ranges of variance. If so, flow 500 moves to 516. Otherwise, flow 500 terminates at 518 as the identity cannot be authenticated to the level as set

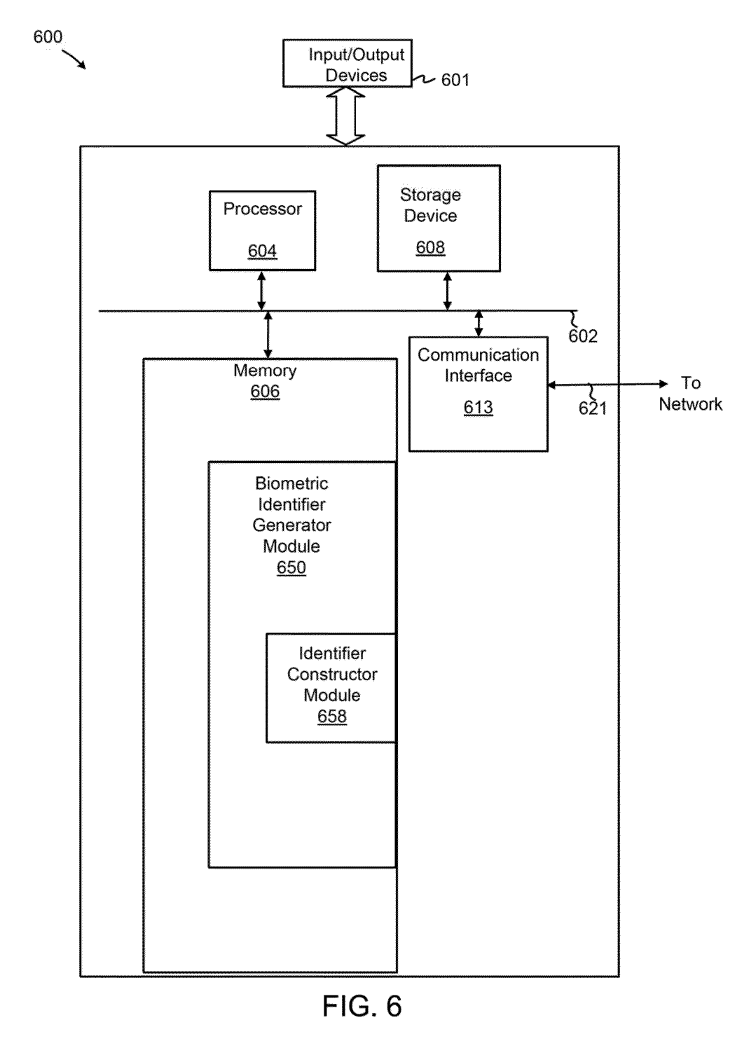

FIG. 6 illustrates an exemplary computing platform disposed in or associated with a wearable device. in some examples, computing platform 600 may be used to implement computer programs, applications, methods, processes, algorithms, or other software to perform the above-described techniques. Computing platform 600 includes a bus 602 or other communication mechanism for communicating information, which interconnects subsystems and devices, such as processor 604, system memory 606 (e.g., RAM, etc.), storage device 608 (e.g., ROM, etc.), a communication interface 613 (e.g., an Ethernet or wireless controller, a Bluetooth controller, etc,) to facilitate communications via a port on communication link 621 to communicate, for example, with a computing device, including mobile computing and/or communication devices with processors. Processor 604 can be implemented with one or more central processing units (“CPUs”), such as those manufactured by Intel® Corporation, or one or more virtual processors, as well as any combination of CPUs and virtual processors. Computing platform 600 exchanges data representing inputs and outputs via input-and-output devices 601, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 600 performs specific operations by processor 604 executing one or more sequences of one or more instructions stored in system memory 606, and computing platform 600 can he implemented in a client-server arrangement, peer-to-peer arrangement, or as any mobile computing device, including smart phones and the like. Such instructions or data may be read into system memory 606 from another computer readable medium, such as storage device 608. In some examples, hard-wired circuitry may be used in place of or in combination with software instructions for implementation. Instructions may he embedded in software or firmware. The term “computer readable medium” refers to any tangible medium that participates in providing instructions to processor 604 for execution. Such a medium may take many forms, including but not limited to, non-volatile media and volatile media. Non-volatile media includes, for example, optical or magnetic disks and the like. Volatile media includes dynamic memory, such as system memory 606.

Common thrills of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 602 for transmitting a computer data signal.

In some examples, execution of the sequences of instructions may be performed by computing platform 600. According to some examples, computing platform 600 can be coupled by communication link 621 (e.g., a wired network, such as LAN, PSTN, or any wireless network) to any other processor to performing the sequence of instructions in coordination with (or asynchronous to) one another. Computing platform 600 may transmit and receive messages, data, and instructions, including program code (e.g., application code) through communication link 621 and communication interface 613. Received program code may be executed by processor 604 as it is received, and/or stored in memory 606 or other non-volatile storage for later execution.

In the example shown, system memory 606 can include various modules that include executable instructions to implement functionalities described herein. In the example shown, system memory 606 includes a biometric identifier generator module 654 configured to determine biometric information relating, to a user that is wearing a wearable device. Biometric identifier generator module 654 can include an identifier construction module 658, which can be configured to provide one or more functions described herein.

In some embodiments, a wearable device 110 of FIG. 1 can be in communication (e.g., wired or wirelessly) with a mobile device 130, such as a mobile phone or computing device. In some cases, mobile device 130, or any networked computing device (not shown) in communication with wearable device 110a or mobile device 130, can provide at least some of the structures and/or functions of any of the features described herein. As depicted in FIG. 1 and other figures herein, the structures and/or functions of any of the above-described, features can be implemented in software, hardware, firmware, circuitry, or any combination thereof. Note that the structures and constituent elements above, as well as then functionality, may be aggregated or combined with one or more other structures or elements. Alternatively, the elements and then functionality may he subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 1 (or any subsequent figure) can represent one or more algorithms. Or, at least one of the elements can represent a portion of logic including a portion of hardware configured to provide constituent structures and/or functionalities.

For example, biometric identifier generator module 654 and any of its one or more components can be implemented in one or more computing devices (i.e., any mobile computing device, such as a wearable device, or mobile phone, whether worn or carried) that include one or more processors configured to execute one or more algorithms in memory. Thus, at least some of the elements in FIG. 1 (or any subsequent figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, biometric identifier generator module 654, including one or more components, can be implemented in one or more computing devices that include one or more circuits. Thus, at least of the elements in FIG. 1 (or any subsequent figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

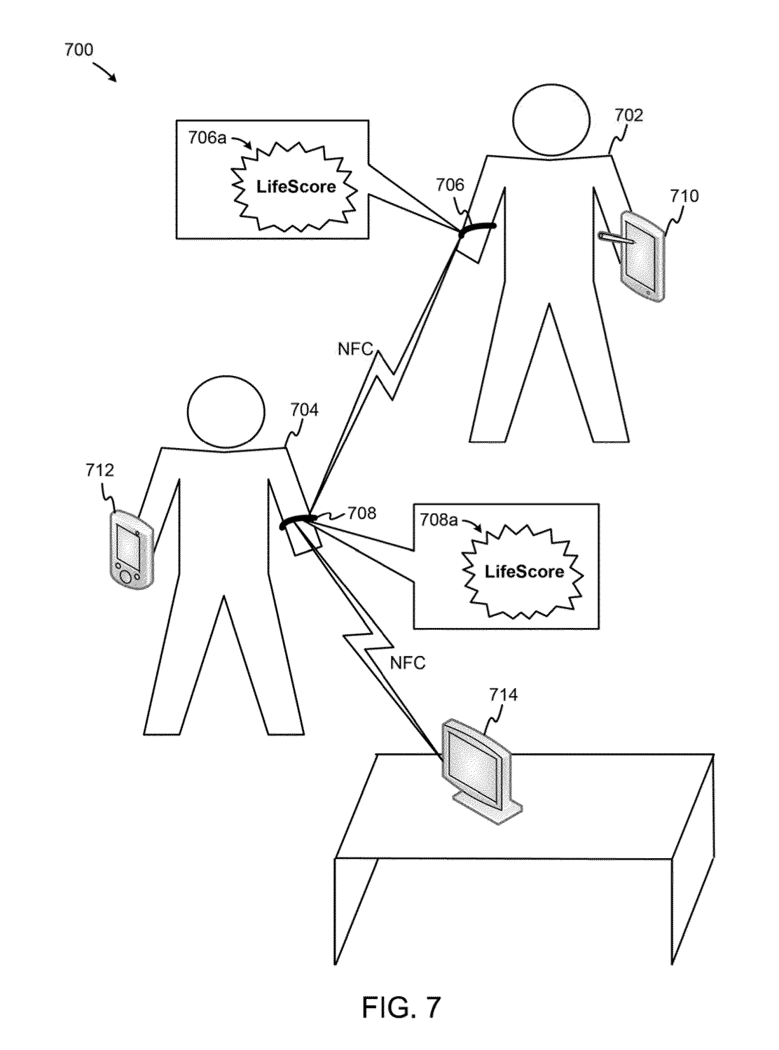

FIG. 7 illustrates an exemplary system for authenticating a user for a transaction using a wearable device. Diagram 700 depicts persons (or “users”) 702 and 704, wearable devices 706 and 708, biometric identifiers (“Lifescores”) 706a and 708a, mobile computing device 710, mobile communications device 712, and payment terminal 714. Like-numbered and named elements in this view may describe the same or substantially similar elements as above. In some examples, wearable device 706 may be configured to generate biometric identifier 706a using data captured by wearable device 706. As described above, wearable device 706 may capture data associated with a habitual activity of person 702, a physiological characteristic of person 702, a motion pattern of person 702, or other activity that person 702 engages in, using one or more of various types of sensors (e.g., sensors 120a-120c and the like). Biometric, identifier 706a may be generated, as described above, to serve as a unique and positive identification of person 702. Thus, wearable device 706 may be configured to store biometric identifier 706a, and other data associated with biometric identifier 706a, to use as an authentication of person 702's identity. Wearable device 708 and biometric identifier 708a may function similarly to wearable device 706 and biometric identifier 706, but with respect to person 704. In other examples, the number, type, function, configuration, appearance, materials or other aspects shown or described may he varied without limitation.

In some examples, wearable devices 706 and 708 may be enabled with near-field communications (NFC) capabilities, and this may be able to establish a two-way radio communication with another NFC-enabled device through touching the two devices together, or bringing them into close enough proximity to establish an NFC connection (i.e., a few centimeters or other close distance sufficient for establishing an NFC link). In some examples, wearable devices 706 and 708 may include an NFC card or chip enabling the generation of a radio frequency (RF) field. Wearable devices 706 and 708 also may be configured to receive data using a radio frequency field. As such, wearable devices 706-708 may he able to communicate data, such as biometric identifiers 706a and 708a, with each other and with other NFC-enabled devices (e.g., payment terminal 714, mobile computing device 710, mobile communications device 712, laptops, other computers, smartphones, other portable computing and communications devices, and the like) configured to receive such data (e.g., using an NFC-enabled tag, sticker, card, or the like). For example, users 702 and 704 may authenticate one or more of their identities for a transaction, or other type of exchange, in a secure manner by placing their respective wearable devices 706 and 708 in close proximity, or touching (i.e., “bumping”) wearable devices 706 and 708 together, to communicate biometric identifier 706a to authenticate user 702's identity and/or biometric identifier 708a to authenticate user 704's identity using NFC, in some examples, wearable devices 706 and 708 may communicate to each other additional information linked to biometric identifiers 706a and 708a (e.g., debit or credit card information, PIN, other account information, or other transaction data). In some examples, wearable devices 706 and 708 may be in data communication with one or more computing devices (e.g., mobile computing device 710, mobile communications device 712, or the like), either through NFC or other methods of data communication (e.g., wired or wireless). In some examples, wearable devices 706 and 708 may receive a request for authentication from the one or more computing devices and may communicate biometric identifiers 706a and 708a, or other indication of an authentication of user 702 and user 704, to the one or more computing devices, which in turn may use biometric identifiers 706a and 708a to authorize a transaction a financial or payment transaction, or the like). In other examples, an authentication using wearable devices 706 and 708 may be initiated differently (e.g., using an interface on wearable devices 706 and 708, automatically upon detection of a signal from a like device, or other initiation indication). In some examples, mobile computing device 710 and mobile communications device 712 may have user interfaces (i.e., provided by a software application) configured to show acknowledgement of an authentication using biometric identifiers 706a and 708a, and other information (e.g., an initiation, duration and completion of a transaction, or the like). In other examples, bands 708-712 may be implemented with user interfaces (not shown) configured to show the same. In still other examples, the number, type, function, configuration, appearance, materials or other aspects shown or described may be varied without limitation.

Similarly, wearable devices 706 and 708 may be configured to authenticate users 702 and 704 for a payment transaction using payment terminal 714 (e.g., at a grocery store, retail store, coffee shop, or other establishment). In some examples, biometric identifiers 706a and 708a may be tagged, linked, or otherwise associated, with data associated with a payment account (e.g., a credit card, banking card, checking account, or the like). In some examples, payment terminal 714 may be NFC-enabled, and thus may be configured to communicate with wearable devices 706 and 708 b touching or coming into close proximity with wearable devices 706 and 708. For example, user 704 may place wearable device 708 on or near payment terminal 714 to communicate (i.e., using NFC), biometric identifier 708a, and data associated with a payment account linked with biometric identifier 708a, in order to authenticate and execute a payment from the payment account. In other examples, the number, type, function, configuration, appearance, materials or other aspects shown or described may be varied without limitation.

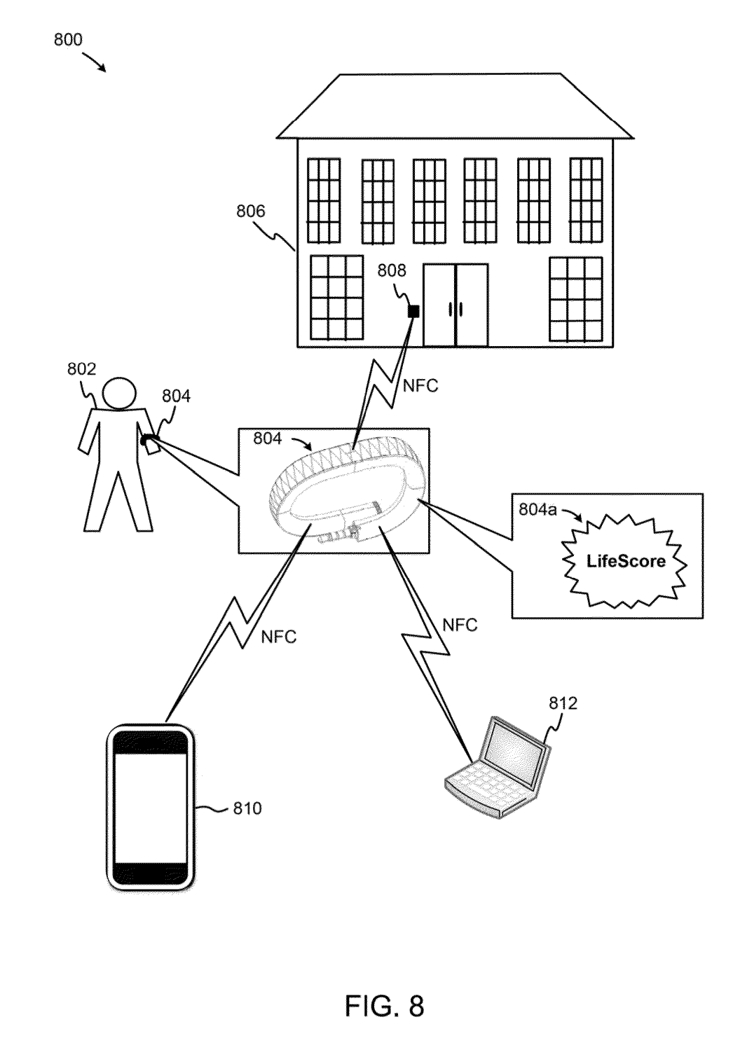

FIG. 8 illustrates an exemplary system for authenticating a user for access using a wearable device. Diagram 800 depicts person (or “user”) 802 wearing wearable device 804, biometric identifier (“Lifescore”) 804a, building 806, access panel 808, mobile computing/communication device 810, laptop 812. Like-numbered and named elements in this view may describe the same or substantially similar elements as above. In some examples, wearable device 804 may comprise sensors configured to capture data associated with a habitual activity of person 802, a physiological characteristic of person 802, a motion pattern of person 802, or other activity that person 802 engages in, in order to generate biometric identifier 804a. As described herein, biometric identifier 804a may serve as a unique and positive identification of person 802, and wearable device 804 may be configured to store biometric identifier 804a, and other data associated with biometric identifier 804a, as an authentication of person 802's identity. In some examples, biometric identifier 804a, or other authentication data authenticating, person 802's identity using, biometric identifier 804a (e.g., an identification or other piece of communicable data linked to biometric identifier 804a, or the like), may be communicated to other NFC-enabled devices (e.g., access panel 808, mobile computing/communication device 810, laptop 812, or the like) to authenticate the identity of person 802 for access (e.g., physical or virtual). For example, user 802 may place wearable device 804 on or near access panel 808 in order to communicate biometric identifier 804a, or other authentication data associated with biometric identifier 804a, to panel 808 and thereby gain access or entry into building 806. in another example, user 802 may place wearable device 804 on or near mobile computing/communication device 810 in order to communicate biometric identifier 804a, or other authentication data associated with biometric identifier 804a, to mobile computing/communication device 810 to gain access to information and programs stored and implemented on mobile computing/communication device 810. In still another example, user 802 may place wearable device 804 on or near laptop 812 in order to communicate biometric identifier 804a, or other authentication data associated with biometric identifier 804a, to gain access to information and programs stored and implemented on laptop 812. In yet other examples, the number, type, function, configuration, appearance, materials or other aspects shown or described may be varied without limitation.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A method, comprising:
capturing data associated with a habitual activity, a physiological characteristic, and a motion pattern using a wearable device comprising a sensor configured to capture the data;
generating a biometric identifier using the data;
storing, the biometric identifier on the wearable device; and
authenticating an identity using the biometric identifier,

2. The method of claim 1, wherein the biometric identifier is configured to distinguish an individual from a plurality of other individuals using at least one of habitual activity data, physiological characteristic data, and motion pattern data.

3. The method of claim 1, wherein generating a biometric identifier comprises generating match data representative of a user associated with the identity.

4. The method of claim 3, wherein the match data comprises a range of values against which at least one of habitual activity data, physiological characteristic data, and motion pattern data is matched during an authentication.

5. The method of claim 1, wherein authenticating an identity using the biometric identifier comprises comparing the data with match data.

6. The method of claim 1, wherein authenticating the identity authorizes a. transaction using another device.

7. The method of claim 6, further comprising communicating transaction data associated with the identity to the another device.

8. The method of claim 1, wherein authenticating the identity comprises communicating the biometric, identifier to another device.

9. The method of claim 1, further comprising receiving a request for authentication from another device.

10. The method of claim 1, further comprising monitoring a rate of change of the physiological characteristic.

11. The method of claim 1, further comprising flagging a change in identification in response to a detection of a high rate of change of the physiological characteristic.

12. A system, comprising:
a wearable device comprising a sensor and configured to capture data associated with a habitual activity, a physiological characteristic, and a motion pattern, the wearable device comprising a storage configured to store a biometric identifier on the wearable device; and
a processor configured to generate a biometric, identifier using the data and to authenticate an identity using the biometric, identifier.

13. The system of claim 12, wherein the wearable device, is configured to communicate the biometric identifier to another device using a near-field communication standard.

14. The system of claim 12, wherein the processor further is configured to implement a biometric identifier generator module comprising an identifier constructor module and configured to generate the biometric identifier.

15. The system of claim 14, wherein the identifier constructor composes a constructor controller configured to modify an authentication process.

16. The system of claim 14, wherein the identifier constructor comprises a constructor controller configured to determine when to modify an authentication process.

17. The system of claim 14, wherein identifier constructor comprises a characteristic compensation unit configured to identify a change in the physiological characteristic.

18. The system of claim 14, wherein identifier constructor comprises a characteristic compensation unit configured to confirm a source of a change in the physiological characteristic.

19. The system of claim 12, further comprising an adaptive threshold generator configured to modify a tolerance associated with the biometric identifier.
